(19) United States
(12) Patent Application Publication
(10) Pub. No.: US 2007/0277384 A1
(43) Pub. Date: Dec. 6, 2007

(54) DRYWALL SCORING AND CUTTING DEVICE

(76) Inventor: Randall N. Rock, Goshen, IN (US)

Correspondence Address: LAW OFFICE OF STEVEN B. LEAVITT, L.L.P., P.O. BOX 537, ROWLETT, TX, 75030-0537, US

(21) Appl. No.: 11/422,167

(22) Filed: Jun. 5, 2006

(51) Int. Cl. B26B 29/00

(52) U.S. Cl. 30/293

(57) ABSTRACT

The present invention is directed to a scoring and cutting device for drywall wherein the device includes a T-square portion having a cross member and an elongated member extending perpendicular from the cross member. At least one roller is rotatably mounted to the bottom surface of the cross member, such that the roller is able to bear against and roll along an edge of a drywall sheet. The device includes a plurality of orifices or receptacles located on elongated member for receiving an instrument to produce a straight cut or score line on the surface of the drywall sheet as elongated member is moved across the surface of the drywall sheet via the at least one roller. The present invention is further directed to a scoring and cutting device comprising a slidably adjustable instrument that produce a straight cut or score line on the surface of the drywall sheet as elongated member is moved across the surface of the drywall sheet via the at least one roller.

### BACKGROUND OF THE INVENTION

1. Technical Field

This invention relates generally to cutting devices, and more particularly, to a device for cutting or scoring drywall.

2. Description of Related Art

Drywall is widely used in residential and commercial construction and is made of a compressed gypsum core with heavy paper glued to both sides. Drywall sheets are available in sizes ranging from 4 feet×8 feet to 4 feet×16 feet, and typically have a thickness between ¼ inch and 1 inch.

Prior to installation, drywall often needs to be cut in order to fit specific dimensions. The process of cutting drywall typically involves numerous steps, and many workers find it to be tedious and time consuming. Currently, the first step in cutting drywall to a desired length is to determine what length and width are needed. Then, the desired length and/or width is measured and appropriately marked on the drywall sheet. Typically, the top and bottom edges of the sheet are appropriately marked and a chalk line is used to create a line between the two marks. Next, the line is scored with a utility knife or some other similar scoring or cutting instrument and the drywall sheet is snapped along the score line to cut or break the drywall into the desired length and/or width. It may be necessary to cut the paper on the opposite side of the drywall sheet to separate the two new drywall pieces.

This process is tedious and time consuming. What is needed is an apparatus that can be used to measure and cut drywall in one simple step and is less tedious and time consuming than the current method.

### SUMMARY OF INVENTION

The present invention solves the above-described problem by providing a device for cutting or scoring drywall such as wallboard, plasterboard, or sheetrock in one simple step. In addition, the device of the present invention can be used on drywall of any length, and can be used to create a cut or score line along either the length or width of the drywall sheet.

The scoring and cutting device of the present invention includes a T-square portion having a cross member and an elongated member extending perpendicular from the cross member. The cross member has a top surface and a bottom surface, and elongated member has a front surface and a back surface. At least a portion of the bottom surface of the cross member extends perpendicular parallel to the back surface of elongated member.

Elongated member comprises indicia identifying units of measurement and a plurality of orifices corresponding to each indicium. The orifices may be in the shape of slits, circles, diamonds, squares, or rectangles and are located on the front surface of elongated member, and are for receiving a scoring or cutting instrument. The scoring or cutting instrument is used to produce a straight cut or score line on the surface of the drywall sheet as elongated member is moved across the surface of the drywall sheet via at least one roller. The at least one roller is rotatably mounted to the bottom surface of the cross member, such that the at least one roller is able to bear against and roll along an edge of a drywall sheet.

Another aspect of the present invention includes a T-square portion having a cross member and an elongated member extending perpendicular from the cross member. The cross member has a top surface and a bottom surface, and elongated member has a front surface and a back surface. At least a portion of the bottom surface of the cross member extends perpendicular parallel to the back surface of elongated member.

Elongated member comprises indicia identifying units of measurement and a slidably adjustable instrument is connected to elongated member. The slidably adjustable instrument is capable of being positioned proximate to a selected indicia and is used to produce a straight cut or score line on the surface of the drywall sheet as elongated member is moved across the surface of the drywall sheet via at least one roller. The at least one roller is rotatably mounted to the bottom surface of the cross member, such that the at least one roller is able to bear against and roll along an edge of a drywall sheet. The slidably adjustable instrument is preferably a blade such as a razor blade.

Other features and advantages of the present invention will become apparent upon reading the following detailed description of embodiments of the invention, when taken in conjunction with the appended claims.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a front view of a scoring and cutting device made in accordance with an embodiment of the present invention;

FIG. 2 is a side view of a scoring and cutting device made in accordance with an embodiment of the present invention;

FIG. 3 is a front view of a scoring and cutting device made in accordance with an alternative embodiment of the present invention;

FIG. 4 is a front view of a scoring and cutting device made in accordance with an alternative embodiment of the present invention;

FIG. 5 is a side view of a roller in accordance with an embodiment of the present invention; and

FIG. 6 is a side view of a roller in accordance with an alternative embodiment of the present invention.

### DETAILED DESCRIPTION OF THE INVENTION

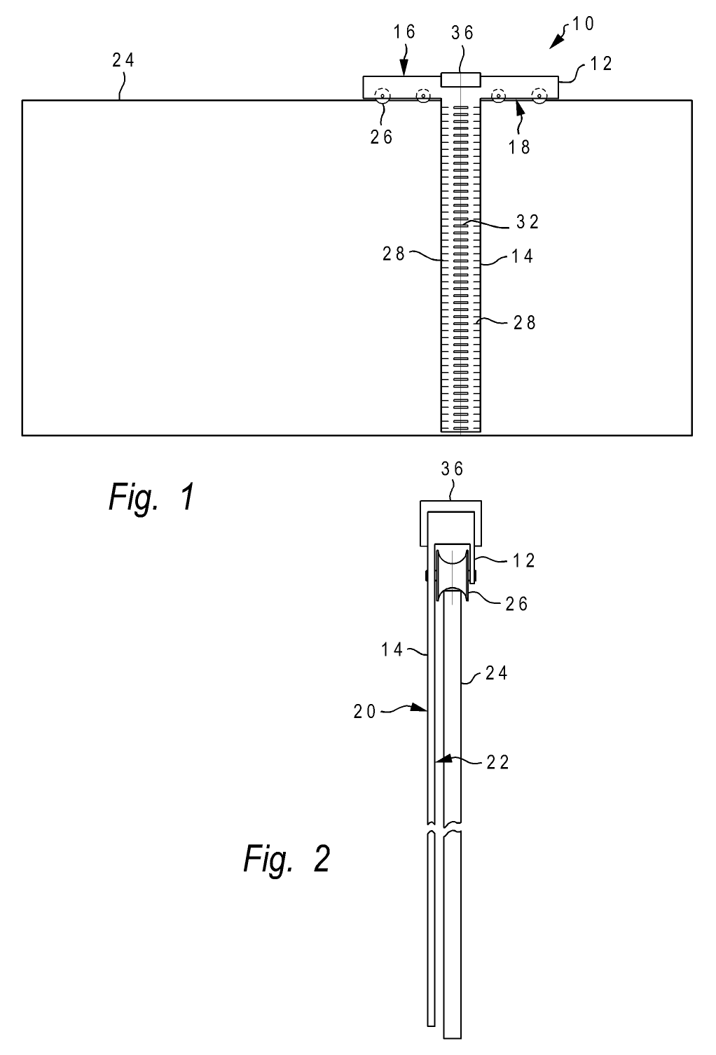

Referring to FIGS. 1 and 2, shown is drywall scoring and cutting device 10 comprising cross member 12 and elongated member 14 extending perpendicular from cross member 12. Elongated member 14 preferably extends perpendicular from the center of cross member 12 to form a T shape. Cross member 12 has a top surface 16 and a bottom surface 18. Elongated member 14 has a front surface 20 and a back surface 22 (FIG. 2). During use of the scoring and cutting device 10, back surface 22 of elongated member 14 faces the surface of drywall sheet 24 to be scored or cut. At least a portion of bottom surface 18 of cross member 12 is proximate to and perpendicular to back surface 22 of elongated member 14.

Elongated member 14 desirably has a length between about 36.0 inches and about 60.0 inches, and a width between about 0.5 inches and about 12 inches. Preferably, elongated member 14 has a length of about 47.75 inches to about 48.0 inches, and a width of about 3 inches to about 4 inches. Cross member 12 preferably has a length between about 16.0 inches and about 36.0 inches, and a width between about 1 inch and about 12 inches. More preferably, cross member 12 has a length of about 28.0 inches, and a width of about 4 inches to about 5 inches.

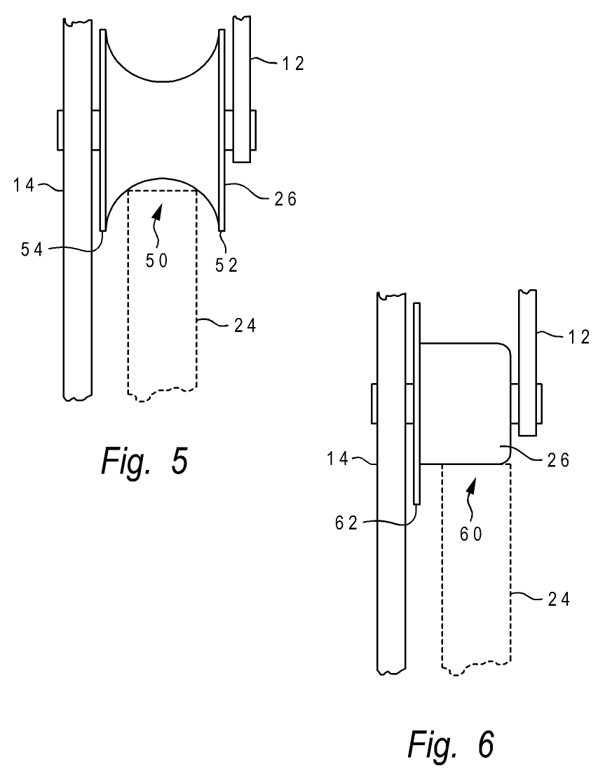

At least one roller 26 is rotatably mounted to bottom surface 18 of cross member 12, such that at least one roller 26 is able to bear against and roll along an edge of drywall sheet 24 during the use of scoring and cutting device 10. FIG. 5 shows roller 26 on an edge of drywall sheet 24. Roller 26 contains inside edge 52, outside edge 54, and U-shaped section 50. Outside edge 54 is proximate to back surface 22 of elongated member 14 and covers at least a portion of one side of drywall sheet 24. Inside edge 52 covers at least a portion of the side opposite to the side outside edge 54 at least partially covers. U-shaped section 50 is between inside edge 52 and outside edge 54 and is wide enough to contain the top edge of drywall sheet 24. Preferably, U-shaped section 50 is about ¼ an inch to about 1 inch wide. In use, U-shaped section 50 rolls on the top edge of drywall sheet 24 while inside edge 52 and outside edge 54 help keep at least one roller 26 bearing against and rolling along an edge of drywall sheet 24.

In another embodiment, shown in FIG. 6, roller 26 contains single outside edge 62 and half U-shaped profile 60. Single outside edge 62 is proximate to back surface 22 of elongated member 14 and covers at least a portion of one side of drywall sheet 24. In use, half U-shaped profile 60 rolls on the top edge of drywall sheet 24 while single outside edge 62 help keep at least one roller 26 bearing against and rolling along an edge of drywall sheet 24.

Preferably, four rollers 26 are rotatably mounted to bottom surface 18 of cross member 12. At least one roller 26 may be comprised of any durable material which enables steady movement of cross member 12 along the edge of the drywall sheet 24. Suitable materials include, but are not limited to plastic, rubber, steel, metal, ceramic, and other similar materials.

Front surface 20 of elongated member 14 comprises indicia 28 identifying units of measurement. Indicia 28 may represent any units of measurement, including, but not limited to feet, inches, centimeters, and millimeters. Indicia 28 are preferably located along the entire length of elongated member 14.

In addition, a plurality of receiving orifices 32 are located on front surface 20 of elongated member 14. The location of each orifice 32 on elongated member 14 corresponds to a different measurement identified by indicia 28 on elongated member 14. Orifices 32 may be any shape that allows a scoring or cutting instrument to come into contact with drywall sheet 24 yet still maintain the structural integrity of elongated member 14. Suitable shapes include, but are not limited to slits, circles or diamonds. Preferably, orifices 32 are in the shape of slits.

During operation of scoring and cutting device 10, bottom surface 18 of cross member 12 is placed against an edge of drywall sheet 24, wherein the drywall sheet edge is parallel to the desired cut or score line to be made in the sheet. Back surface 22 of elongated member 14 faces the surface of drywall sheet 24 that is to be scored and/or cut. The appropriate measurement for the score and/or cut line to be made is located on elongated member 14 using indicia 28. Then, a scoring or cutting instrument as is know in the art is placed in orifice 32 that corresponds to the related indicia 28.

After the scoring or cutting instrument is placed in the corresponding orifice 32, it is brought into contact with drywall sheet 24 and sufficient pressure is applied to score or cut drywall sheet 24. The amount of pressure to score or cut drywall 24 is commonly known in the art. Because the scoring or cutting instrument is in contact with drywall 24 with sufficient pressure to score or cut drywall sheet 24, the scoring or cutting instrument produces a straight cut or score line on the surface of the drywall sheet 24 as cross member 12 is moved along the edge of the drywall sheet 24. If necessary, after drywall sheet 24 has been scored or cut, conventional methods known to those having skill in the art may then be used to separate drywall sheet 24 into two pieces.

Any instrument that is capable of being inserted into orifice 32 on elongated member 14 and is able to form a cut or score line on the surface of the drywall sheet 24, may be used. For example, suitable instruments include, but are not limited to a knife, such as a utility knife; a carpenter pencil; a blade, screw driver, or any other instrument known in the art to be used to score or cut drywall.

Scoring and cutting device 10 may also include handle 36. Handle 36 is attached to cross member 12 and may be used to hold scoring and cutting device 10 steady during operation and to move cross member 12 along the edge of the drywall sheet 24 during operation of scoring and cutting device 10.

The components of scoring and cutting device 10 may be comprised of any material that is lightweight, durable enough to maintain its shape during use, and also allows the device to produce accurately measured score and/or cut lines. Suitable materials cross member 12, elongated member 14, and handle 36 may be comprised of include, but are not limited to plastic, aluminum, iron, metal, ceramic, or other similar materials.

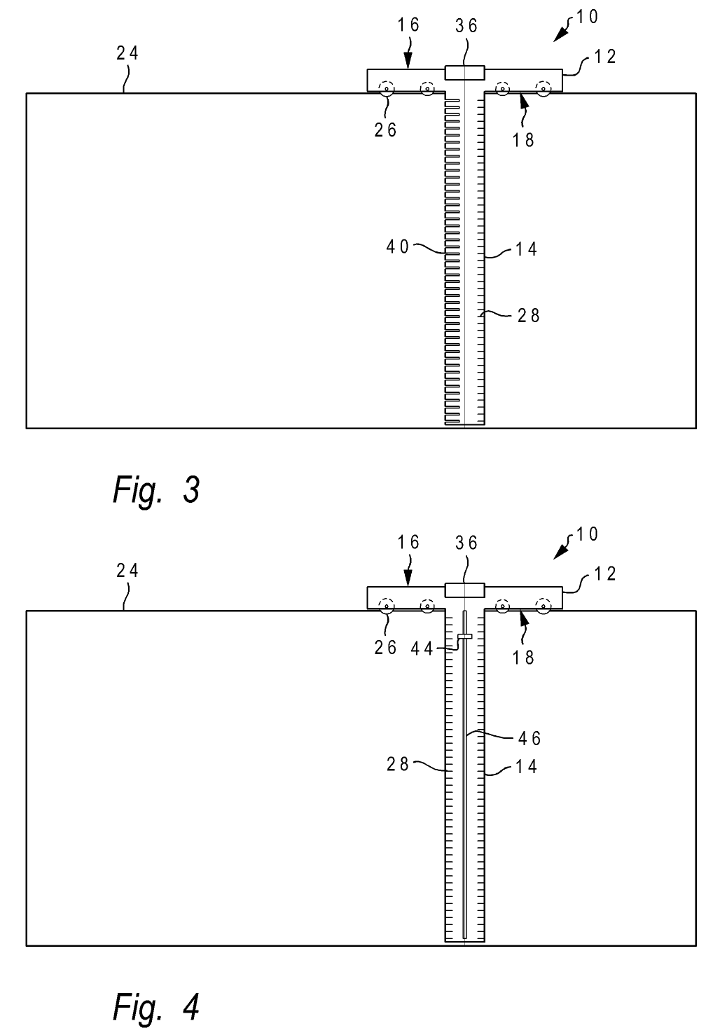

In an alternative embodiment, as shown in FIG. 3, elongated member 14 comprises a plurality of receptacles 40 instead of receiving orifices 32. The plurality of receptacles 40 is preferably located along the length of elongated member 14, and may be located proximate the center of front surface 20, or proximate to a side edge of elongated member 14, as shown in FIG. 3. The location of each receptacle 40 corresponds to a different measurement identified by indicia 28 on elongated member 14.

Each receptacle 40 may be any shape that is capable of receiving and holding an instrument steady within the receptacle. Suitable shapes include, but are not limited to a slit, diamond, square, or rectangle. Preferably, each receptacle 40 is in the shape of a slit.

During operation of scoring and cutting device 10, bottom surface 18 of cross member 12 is placed against an edge of drywall sheet 24, wherein the drywall sheet edge is parallel to the desired cut or score line to be made in the sheet. Back surface 22 of elongated member 14 faces the surface of drywall sheet 24 that is to be scored and/or cut. The appropriate measurement for the score and/or cut line to be made is located on elongated member 14 using indicia 28. Then, a scoring or cutting instrument as is know in the art is placed in the receptacle 40 that corresponds to the related indicia 28.

After the scoring or cutting instrument is placed in the corresponding receptacle 40, it is brought into contact with drywall sheet 24 and sufficient pressure is applied to score or cut drywall sheet 24. The amount of pressure to score or cut drywall 24 is commonly known in the art. Because the scoring or cutting instrument is in contact with drywall 24 with sufficient pressure to score or cut drywall sheet 24, the scoring or cutting instrument produces a straight cut or score line on the surface of the drywall sheet 24 as cross member 12 is moved along the edge of the drywall sheet 24. If necessary, after drywall sheet 24 has been scored or cut, conventional methods known to those having skill in the art may then be used to separate drywall sheet 24 into two pieces.

Any instrument that is capable of being inserted into receptacle 40 on elongated member 10 and is able to form a cut or score line on the surface of the drywall sheet 24, may be used. Suitable instruments include, but are not limited to a knife, such as a utility knife; a carpenter pencil; a blade, screw driver, or any other instrument known in the art to be used to score or cut drywall.

In each of the embodiments described above, the scoring or cutting instrument may be adjusted relative to elongated member 14. Specifically, the portion of the instrument extending from back surface 22 of elongated member 14 and the pressure applied to scoring or cutting instrument may be increased to produce a deeper score or cut line, or may be decreased to produce a more shallow score or cut line in drywall sheet 24.

In yet another alternative embodiment, shown in FIG. 4, the scoring and cutting device 10 includes a slidably adjustable instrument 44 connected to elongated member 14. This embodiment, unlike the previously discussed embodiments, does not include a plurality of orifices 32 or receptacles 40. Slidably adjustable instrument 44 may be positioned and locked in place to correspond to any measurement identified by indicia 28 on elongated member 14. Elongated member 14 may include longitudinal slit 46, along which the slidably adjustable instrument 44 is moved and positioned. Any mechanism known to those having skill in the art may be used to lock slidably adjustable instrument 44 in place after it is positioned. An example of such a mechanism is a spring lock or pressure lock.

During operation of scoring and cutting device 10, bottom surface 18 of cross member 12 is placed against an edge of drywall sheet 24, wherein the drywall sheet edge is parallel to the desired cut or score line to be made in the sheet. Back surface 22 of elongated member 14 faces the surface of drywall sheet 24 that is to be scored and/or cut. The appropriate measurement for the score and/or cut line to be made is located on elongated member 14 using indicia 28. Then, slidably adjustable instrument 44 is moved to and placed at a position that corresponds to the related indicia 28. In one embodiment, slidably adjustable instrument 44 is locked in place after it is moved proximate to the related indicia.

After slidably adjustable instrument 44 is moved into place, it is brought into contact with drywall sheet 24 and sufficient pressure is applied to score or cut drywall sheet 24. The amount of pressure to score or cut drywall 24 is commonly known in the art. Because slidably adjustable instrument 44 is in contact with drywall 24 with sufficient pressure to score or cut drywall sheet 24, slidably adjustable instrument 44 produces a straight cut or score line on the surface of the drywall sheet 24 as cross member 12 is moved along the edge of the drywall sheet 24. If necessary, after drywall sheet 24 has been scored or cut, conventional methods known to those having skill in the art may then be used to separate drywall sheet 24 into two pieces.

The scoring or cutting portion of slidably adjustable instrument 44 may be any device that is capable of forming a cut or score line on the surface of the drywall sheet 24, including, but not limited to a blade or some other similar device. Preferably, the device used is a blade.

The portion of slidably adjustable instrument 44 extending from back surface 22 of elongated member 14 and the pressure applied to slidably adjustable instrument 44 may be increased to produce a deeper score or cut line, or may be decreased to produce a more shallow score or cut line in the drywall sheet 24.

It should be understood that the foregoing relates to exemplary embodiments of the invention and that modifications may be made without departing from the spirit and scope of the invention as set forth in the following claims.

What is claimed is:

1. A device for cutting drywall comprising:
a cross member having a top surface and a bottom surface;
an elongated member having a front surface and a back surface, wherein the elongated member extends perpendicular from the cross member and contains indicia identifying units of measurement;
at least one roller rotatably mounted to the bottom surface of the cross member such that the roller is able to bear against and roll along an edge of a drywall sheet; and
a plurality of orifices located on the front surface of elongated member wherein each orifice corresponds to a different measurement identified by the indicia and each of the plurality of orifices are for receiving an instrument that produces a straight cut or score line on the surface of a drywall sheet as the cross member is moved along an edge of the drywall sheet.

2. The device of claim 1, wherein the orifices are in the shape of slits, circles or diamonds.

3. The device of claim 1, wherein elongated member has a length between about 36.0 inches and about 60.0 inches.

4. The device of claim 3, wherein elongated member has a length of about 48.0 inches.

5. The device of claim 1, wherein the cross member has a length between about 16.0 inches and about 36.0 inches.

6. The device of claim 5, wherein the cross member has a length of about 28.0 inches.

7. The device of claim 1, further comprising a handle located on the cross member for guiding the cross member along the edge of the drywall sheet.

8. A device for cutting drywall comprising:
a cross member having a top surface and a bottom surface;
an elongated member having a front surface and a back surface, wherein the elongated member extends perpendicular from the cross member and contains indicia identifying units of measurement;
at least one roller rotatably mounted to the bottom surface of the cross member such that the roller is able to bear against and roll along an edge of a drywall sheet; and
a plurality of receptacles located on a side of elongated member wherein each receptacles corresponds to a different measurement identified by the indicia and each of the plurality of receptacles are for receiving an instrument that produces a straight cut or score line on the surface of a drywall sheet as the cross member is moved along an edge of the drywall sheet.

9. The device of claim 8, wherein elongated member has a length between about 36.0 inches and about 60.0 inches.

10. The device of claim 9, wherein elongated member has a length of about 48.0 inches.

11. The device of claim 8, wherein the cross member has a length between about 16.0 inches and about 36.0 inches.

12. The device of claim 11, wherein the cross member has a length of about 28.0 inches.

13. The device of claim 8, further comprising a handle located on the cross member for guiding the cross member along the edge of the drywall sheet.

14. A device for cutting drywall comprising:
a cross member having a top surface and a bottom surface;
an elongated member having a front surface and a back surface, wherein the elongated member extends perpendicular from the cross member and contains indicia identifying units of measurement;
at least one roller rotatably mounted to the bottom surface of the cross member such that the roller is able to bear against and roll along an edge of a drywall sheet; and
a slidably adjustable instrument connected to elongated member wherein the position of the slidably adjustable instrument may be moved to correspond to any measurement identified by the indicia and the instrument is capable of producing a straight cut or score line on the surface of a drywall sheet as the cross member is moved along an edge of the drywall sheet.

15. The device of claim 14, wherein the instrument is a blade.

16. The device of claim 14, wherein elongated member has a length between about 36.0 inches and about 60.0 inches.

17. The device of claim 16, wherein elongated member has a length of about 48.0 inches.

18. The device of claim 14, wherein the cross member has a length between about 16.0 inches and about 36.0 inches.

19. The device of claim 18, wherein the cross member has a length of about 28.0 inches.

20. The device of claim 14, further comprising a handle located on the cross member for guiding the cross member along the edge of the drywall sheet.
